(19) United States
(12) Patent Application Publication
(10) Pub. No.: US 2026/0348797 A1
(43) Pub. Date: Nov. 5, 2026

(54) SYSTEMS AND METHODS FOR SAMPLING

(71) Applicant: DH Technologies Development Pte. Ltd., Singapore (SG)

(72) Inventors: Stephen TATE, Barrie (CA); Yves LE BLANC, Newmarket (CA); Thomas R. COVEY, Newmarket (CA)

(73) Assignee: DH Technologies Development Pte. Ltd., Singapore (SG)

(21) Appl. No.: 19/731,236

(22) Filed: Jul. 6, 2026

Related U.S. Application Data
(62) Division of application No. 18/547,787, filed on Feb. 24, 2022, now Pat. No. 12,704,441.
(60) Provisional application No. 63/218,754, filed on Jul. 6, 2021.
(60) Provisional application No. 63/153,586, filed on Feb. 25, 2021.

(51) Int. Cl. G01N 1/14; G01N 1/38; G01N 30/72; G01N 30/02

(52) U.S. Cl. CPC G01N 1/14; G01N 1/38; G01N 30/7233; G01N 2001/149; G01N 2030/027

(57) ABSTRACT

A system includes a capillary having a first end connected to a sampling device and a second end. The sampling device is configured to separate a sample with a separation solution and deliver the sample and the separation solution to the second end. The second end is coupled to a capillary ground contact. A transport liquid supply system in fluidic communication with a transport liquid supply conduit provides a transport liquid from a transport liquid source through the transport liquid supply conduit. The transport liquid provided from the transport liquid supply conduit includes a receiving volume defined at least in part by a meniscus. The second end of the capillary is in fluidic communication with the receiving volume. A liquid exhaust system in fluidic communication with a removal conduit removes liquid from the receiving volume. An analysis system is in fluidic communication with the removal conduit.

### BACKGROUND

Mass spectrometry (MS) based methods can achieve label-free, universal mass detection of a wide range of analytes with exceptional sensitivity, selectivity, and specificity. As a result, there is significant interest in improving the throughput of MS-based analysis for many applications.

### SUMMARY

In one aspect, the technology relates to a system including: a capillary having a first end connected to a sampling device and a second end, wherein the sampling device is configured to separate a sample with a separation solution and deliver the sample and the separation solution to the second end, wherein the second end is coupled to a capillary ground contact; a transport liquid supply system in fluidic communication with a transport liquid supply conduit that provides a transport liquid from a transport liquid source through the transport liquid supply conduit, wherein the transport liquid provided from the transport liquid supply conduit includes a receiving volume defined at least in part by a meniscus, and wherein the second end of the capillary is in fluidic communication with the receiving volume; a liquid exhaust system in fluidic communication with a removal conduit that removes liquid from the receiving volume; an electrical conductor for connecting the transport liquid supply conduit to the removal conduit; a first electrical contact connected to the transport liquid supply conduit; and an analysis system in fluidic communication with the removal conduit. In an example, the second end of the capillary is disposed within the meniscus and wherein the capillary ground contact includes at least in part the receiving volume. In another example, the second end of the capillary is disposed in the removal conduit and wherein the capillary ground contact includes at least in part the receiving volume. In yet another example, a perimeter of the second end of the capillary is spaced apart from the removal conduit. In still another example, the system further includes an interface coupled to the transport liquid supply conduit and the second end of the capillary, wherein the interface defines the receiving volume proximate the removal conduit.

In another example of the above aspect, the second end of the capillary further includes a conductive tip and wherein the capillary ground contact is connected to the conductive tip. In an example, the interface includes at least one flexible element. In another example, the flexible element includes at least one of rubber, polyurethane, neoprene, and silicone. In yet another example, the sampling device performs capillary electrophoresis or liquid chromatography. In still another example, the analysis system is a mass spectrometer.

In another example of the above aspect, the tip is disposed remote from and above the meniscus.

In another aspect, the technology relates to a method for analyzing a sample, the method including: receiving the sample and a separation solution from a capillary, wherein the capillary has a first end connected to a sampling device and a second end coupled to a capillary ground contact, wherein the sampling device is configured to separate the sample from the separation solution, wherein the sample and the separation solution is received from the second end and into a receiving volume defined at least in part by a transport liquid delivered from a transport liquid supply conduit; aspirating the received sample and the separation solution into a liquid exhaust system in fluidic communication with a removal conduit in fluidic communication with the receiving volume; and analyzing the received sample and separation solution with a mass analysis system. In an example, the method further includes supplying the transport liquid to the transport liquid supply conduit from a transport liquid supply system in fluidic communication with the transport liquid supply conduit. In another example, the receiving volume is defined at least in part by a meniscus. In yet another example, the method further includes receiving the second end of the capillary within the meniscus. In still another example, a perimeter of the second end of the capillary is in contact with the removal conduit.

In another example of the above aspect, the method further includes receiving an interface defining the receiving volume proximate the removal conduit. In an example, the interface includes at least one flexible element. In another example, the sampling device performs at least one of capillary electrophoresis and liquid chromatography to obtain the sample. In yet another example, the method further includes receiving the sample and the separation solution from the capillary, wherein the sample and the separation solution are released from the second end of the capillary under gravity into the receiving volume. In still another example, the separation solution is diluted by the transport liquid to allow for ionization by the mass analysis system.

### BRIEF DESCRIPTION OF THE DRAWINGS

FIG. 1 is a schematic view of an example system combining a sampling device with an open port interface (OPI) sampling interface and an electrospray ionization (ESI) source.

FIG. 2A depicts an enlarged partial view of an example system for analyzing a separated sample from a capillary electrophoresis (CE) capillary.

FIG. 2B depicts an enlarged partial view of an example system for analyzing a separated sample from a liquid chromatography (LC) capillary.

FIG. 3A depicts another enlarged partial view of an example system for analyzing a separated sample from a CE capillary.

FIG. 3B depicts another enlarged partial view of an example system for analyzing a separated sample from an LC capillary.

FIG. 4A another enlarged partial view of an example system for analyzing a separated sample from a CE capillary using an interface.

FIG. 4B depicts another enlarged partial view of an example system for analyzing a separated sample from an LC capillary using an interface.

FIG. 5A depicts another enlarged partial view of an example system for analyzing a separated sample from a CE capillary.

FIG. 5B depicts another enlarged partial view of an example system for analyzing a separated sample from an LC capillary.

FIG. 6 depicts a method for analyzing a separated sample.

FIG. 7 depicts an example of a suitable operating environment in which one or more of the present examples can be implemented.

### DETAILED DESCRIPTION

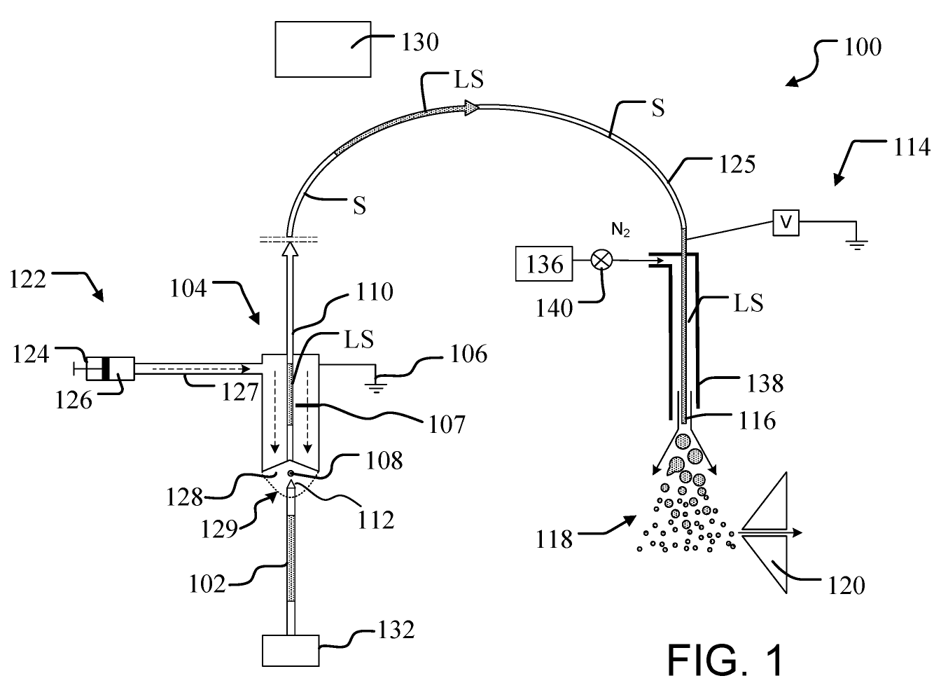

FIG. 1 is a schematic view of an example system 100 combining a capillary 102 connected to a sampling device 132 with an OPI sampling interface 104 and ESI source 114. The system 100 may be a mass analysis instrument such as a mass spectrometry device that is for ionizing and mass analyzing analytes received within an open end of a sampling OPI. Such a system 100 is described, for example, in U.S. Pat. No. 10,770,277, the disclosure of which is incorporated by reference herein in its entirety. The capillary 102 is configured to release or eject an eluent 108, containing separated analytes from a sample in a buffer solution, from an end having a tip 112 into the open end of sampling OPI 104. The capillary 102 is connected at a first end to a sampling device 132, examples of which are described below. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer probe 138 and electrospray electrode 116 of the ESI source 114, samples ejected therefrom are transformed into the gas phase. A transport liquid supply system 122 (e.g., including one or more pumps 124 and one or more conduits 125) provides for the flow of liquid from a transport liquid source or reservoir 126 to the sampling OPI 104 and from the sampling OPI 104 to the ESI source 114. The transport liquid source 126 (e.g., containing a liquid, desorption solvent) can be in fluidic communication with the sampling OPI 104 via a transport liquid supply conduit 127 through which the transport liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, the flow of liquid into and out of the sampling OPI 104 occurs within a receiving volume 128 defined at least in part by a meniscus 129 accessible at the open end of the sampling OPI 104 such that one or more eluent droplets 108 can be introduced into the receiving volume 128 and subsequently delivered to the ESI source 114. A removal conduit 110 forms one part of a liquid exhaust system that connects the OPI 104 to the ESI 114, and removes the transport liquid and any eluent droplet 108 from the OPI 104. An electrical contact 106 is disposed on the OPI 104 and an electrical conductor 107 connects the outer portion of the OPI 104 (that forms a part of the transport liquid supply conduit 127) to the removal conduit 110 to ensure grounding thereof.

A controller 130 can be operatively coupled to the various components of the system 100 for operation thereof. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art.

As shown in FIG. 1, the ESI source 114 can include a source 136 of pressurized gas (e.g. nitrogen, air, or a noble gas) that supplies a high velocity nebulizing gas flow to the nebulizer probe 138 that surrounds the outlet end of the electrospray electrode 116. As depicted, the electrospray electrode 116 protrudes from a distal end of the nebulizer probe 138. The pressured gas interacts with the liquid discharged from the electrospray electrode 116 to enhance the formation of the sample plume and the ion release within the plume for sampling by mass analyzer detector 120, e.g., via the interaction of the high speed nebulizing flow and jet of a liquid sample LS (e.g., a dilution of the transport fluid S and the eluent received from the sampling device 132). The discrete volumes of liquid samples LS are typically separated from each other by volumes of the transport liquid S. The nebulizer gas can be supplied at a variety of flow rates, for example, in a range from about 0.1 L/min to about 20 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect). A voltage, e.g., 5kV, is applied to the electrospray electrode 116 during operation, thus creating an electrical potential between the electrospray electrode 116 and the grounded OPI 104. The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled "Product ion scanning using a Q-q-Q linear ion trap (Q TRAP) mass spectrometer," authored by James W. Hager and J. C. Yves Le Blanc and published in Rapid Communications in Mass Spectrometry (2003; 17: 1056-1064); and U.S. Pat. No. 7,923,681, entitled "Collision Cell for Mass Spectrometer," the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, linear ion traps, 3D traps, electrostatic traps, hybrid analyzers, and other known mass spectrometers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference between in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

As shown in FIG. 1, the sampling device 132 is interfaced with an OPI 104 to provide a sample introduction system for high-throughput mass spectrometry. In an example, the sampling device 132 performs capillary electrophoresis (CE) and a CE capillary 102 is interfaced with the OPI 104. In other examples, the sampling device 132 performs liquid chromatography (LC) and an LC capillary 102 is interfaced with the OPI 104. When a CE or LC capillary 102 is coupled to a mass analysis instrument 120 via the OPI 104, the system can be referred to as a capillary electrophoresis mass spectrometry (CE-MS) system or a liquid chromatography mass spectrometry (LC-MS) system, respectively. The analytical performance (sensitivity, reproducibility, throughput, etc.) of a CE-MS or LC-MS system depends on the performance of the CE or LC device and the OPI. The performance of the CE or LC device and the OPI depends on selecting the operational conditions or parameters for interfacing these devices. Example operational conditions and parameters for interfacing these devices are described herein below.

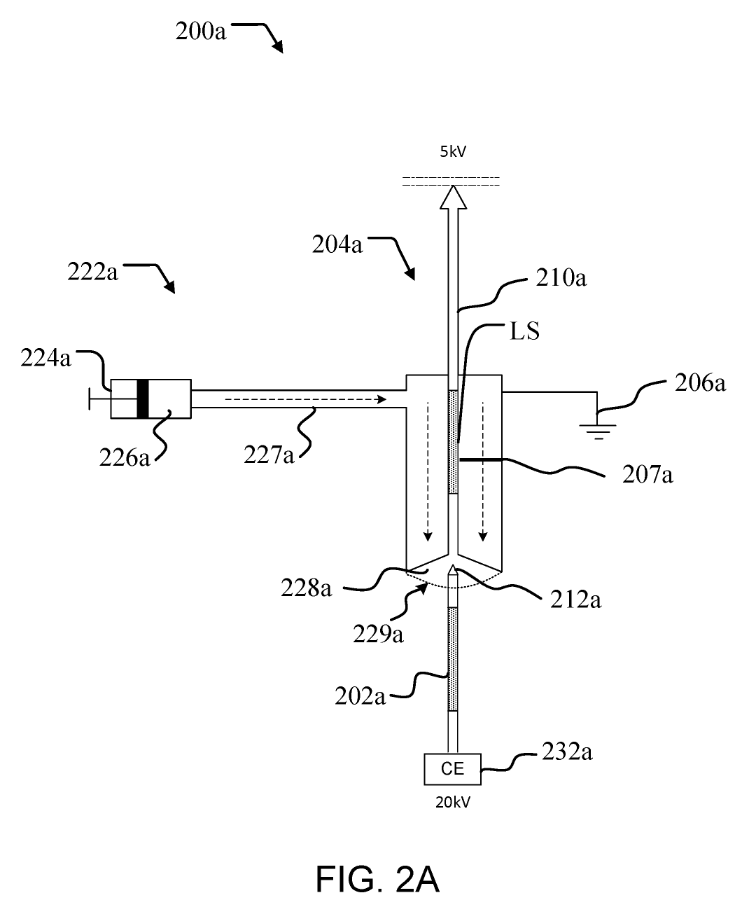

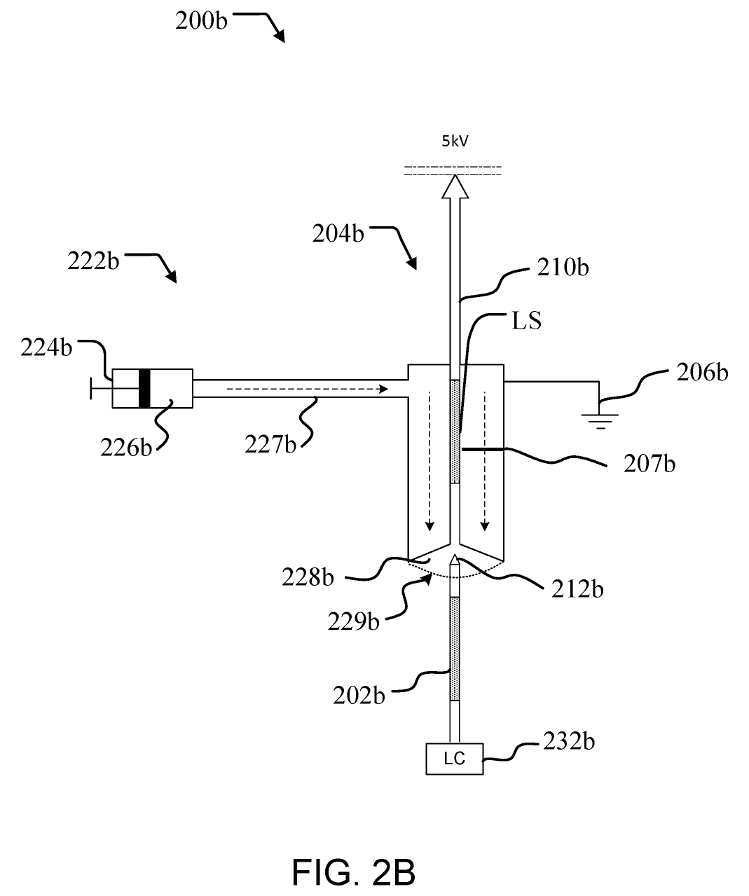

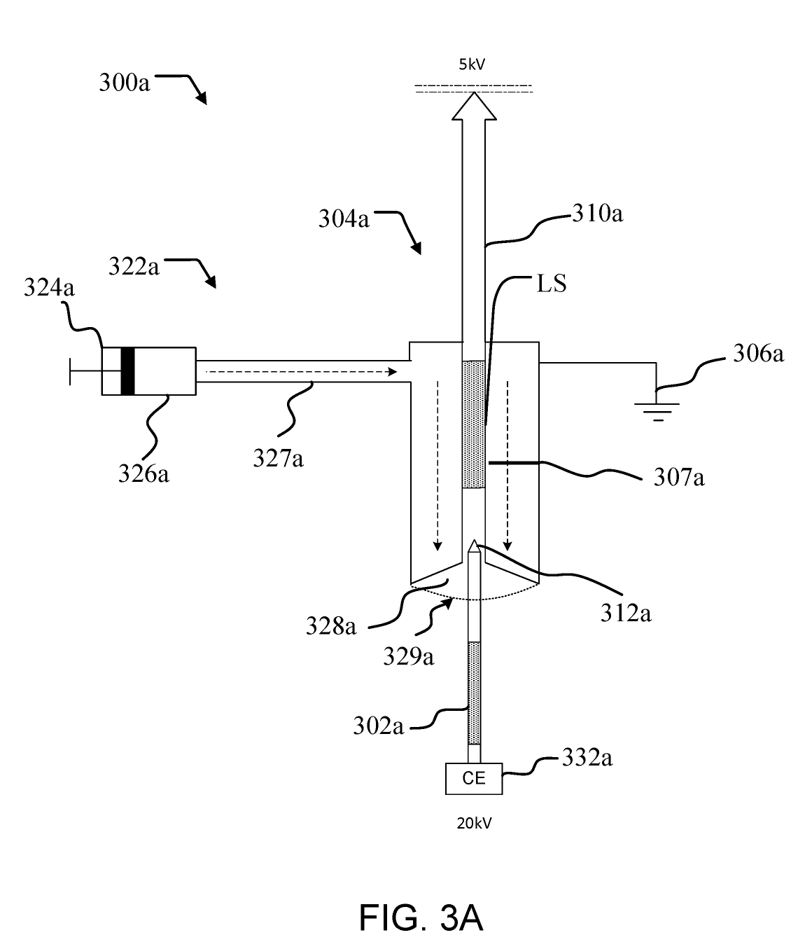

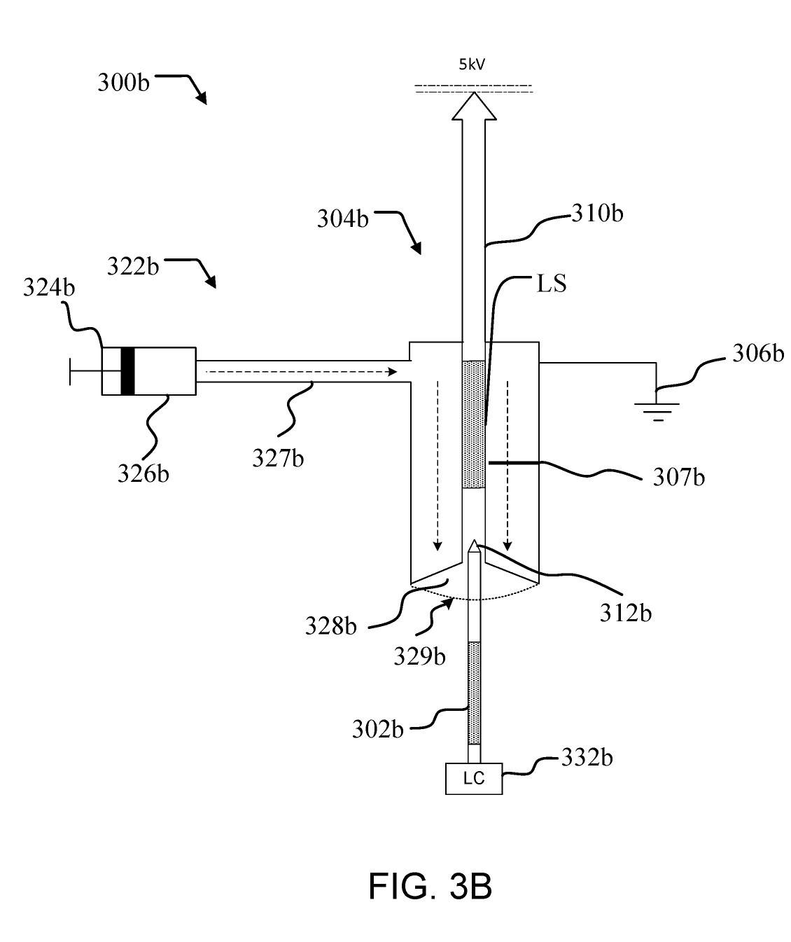

The sampling device 132 may be a CE system. CE is a sample separation method that separates analytes within a sample based on electrophoretic mobility. Standard CE systems utilize a fused silica capillary filled with an electrolyte (e.g., a buffer solution). A sample is introduced into a first end of the capillary. In standard systems, the first end of the capillary is placed in contact with an anode buffer solution and a second end is placed in contact with a cathode buffer solution. A high voltage (e.g., 20kV) is then applied across the capillary to initiate the movement of analytes. The components of the sample move and separate under the influence of the electric field based on differences in electrophoretic mobility. This separated sample may then be delivered to the OPI 104 of the mass spectrometry system 100, as an eluent containing the separated analytes in the buffer solution. FIG. 1 depicts the tip 112 of the capillary 102 disposed below the meniscus 129 of the receiving volume 128. This is but one example configuration and is further depicted and described in FIG. 2A. Other appropriate configurations to enable direct interfacing of a CE system with a mass spectrometry device are depicted in FIGS. 3A, 4A and 5A. Regardless of configuration, in order to maintain the desired electrical potentials in both the ESI electrode 116 (e.g., 5 kV) and the CE system 132 (e.g., 20 kV) the eluent delivered from the CE system 132 is preferably grounded. Examples of such structure of enable this functionality are depicted and described below and include grounding the CE system via the transport liquid and/or the physical structures within the OPI, or grounding via a dedicated capillary ground contact.

The sampling device 132 may be an LC system. LC separates analytes within a sample based on differences in chemical affinity. In standard LC systems, a liquid sample is dissolved in a solvent (e.g., the mobile phase), and then flowed through a system (e.g., a column) containing a stationary phase. The analytes with stronger retention to the stationary phase will take longer to travel through the system, thus causing separation of the sample. The target analytes of the separated sample may then be delivered to the OPI 104 of the mass spectrometry system 100, as described herein. Pressure from the LC system may be used to initiate a controlled flow of an eluent of the separated sample and the solvent from the capillary 102 into the OPI 104. FIG. 1 depicts the tip 112 of the capillary 102 disposed below the meniscus 129 of the receiving volume 128. This is but one example configuration and is further depicted and described in FIG. 2B. Other appropriate configurations to enable direct interfacing of an LC system with a mass spectrometry device are depicted in FIGS. 3B, 4B, and 5B. LC systems can utilize different buffers or solvents, including those that have high conductivity. Such high conductivity liquids are typically incompatible with MS devices. Thus, in the examples depicted herein, the first electrical contact 106 connected to the transport liquid supply conduit grounds the transport liquid, thus enabling a high conductivity buffer to be utilized in the LC system and directly introduced into the OPI 104 for dilution to an extent that avoids ionization suppression in an ion source of the MS system. More specifically, the electrical contact 106 provides a ground that reduces the conductivity of the buffer. This enables an LC system utilizing a high conductivity buffer (e.g., native LC) to be directly interfaced with a MS device through the OPI 104, without further processing of the eluent from the LC system.

FIG. 2A depicts an enlarged partial view of an example system 200a for analyzing a separated sample from a CE capillary 202a. In the system 200a, the capillary 202a has a first end connected to a CE sampling device 232a, and an electric potential (e.g., 20kV) is applied to the CE sampling device 232a. The capillary 202a is interfaced with an OPI 204a by disposing a second end of the capillary having a tip 212a within a receiving volume 228a defined at least in part by a meniscus 229a. Since the receiving volume 228a is open to the atmosphere, the interface between the capillary 202a and receiving volume 228a may be referred to as an atmospheric pressure liquid junction (APLJ), with a meniscus 229a of the transport fluid forming an air-liquid interface. The receiving volume 228a completing the electric circuit, for instance by grounding the liquid in the receiving volume 228a relative to the electric potential applied at the first end of the CE sampling device 232a. The grounding may be applied to a supply source of liquid to the receiving volume 228a, a supply conduit, or at the outlet of the OPI 204a.

In FIG. 2A, the system 200a includes a transport liquid supply system 222a having a pump 224a, a transport liquid source 226a, and a transport liquid supply conduit 227a. The pump 224a is configured to pump transport liquid from the transport liquid supply source 226a into the transport liquid supply conduit 227a at a first flow rate. The transport liquid flows through the transport liquid supply conduit 227a towards the open end of the OPI 204a, where the receiving volume 228a defined at least in part by the meniscus 229a is formed. The tip 212a of the capillary 202a is disposed within the receiving volume 228a such that the eluent from the capillary 202a is released into the receiving volume 228a. The eluent from the capillary 202a is then removed through the removal conduit 210a at a second flow rate. The first flow rate and the second flow rate are configured to allow the transport liquid to form the receiving volume 228a at the open end of the OPI 204a and then be subsequently removed through the removal conduit 210a, without any transport liquid dripping or leaking from the open end of the OPI 204a.

The system 200a further includes an electrical conductor 207a (which may be integrated into the transport liquid supply conduit 227a or discrete therefrom) and a first electrical contact 206a connected to the transport liquid supply conduit 227a. The electrical conductor 207a connects the transport liquid supply conduit 227a to the removal conduit 210a. The first electrical contact 206a is configured to ground the solvent liquid, and the electrical conductor 207a helps ensure that the removal conduit 210a is also grounded. The first electrical contact 206a may include a grounding connector, such as a metal clamp, attached to a grounding wire. So long as the tip 212a of the capillary 202a is in contact with the transport liquid comprising the receiving volume 228a, the eluent released from the capillary 202a will be grounded via the first electrical contact 206a. As will be appreciated, in other examples the transport liquid may be grounded upstream from the OPI 204a, such as a supply conduit or liquid source, provided the liquid is sufficiently conductive to provide an effective ground at the receiving volume 228a. Thus, the two liquid circuits, e.g., the solvent liquid from the CE sampling device 232a and the transport liquid flowing from the OPI 204a, are electrically decoupled. This configuration enables the eluent from the CE capillary 202a to flow directly into the OPI 204a for dilution and transfer of the diluted solution to an electrospray ionization source of the mass analysis system, while isolating and maintaining the required potentials on the CE system (e.g., 20kV) and on the electrospray electrode of the mass analysis system (e.g., 5 kV).

In another example of the configuration depicted in FIG. 2A, the transport liquid supply conduit 227a and discrete pump 224a may be eliminated. Such a configuration is depicted and described in the Appendix, the disclosure of which is hereby incorporated by reference herein in its entirety. Transport liquid is still required for proper operation of the OPI 204a, however, so buffer liquid may be introduced from an outlet vial of the CE sampling device 232a. This buffer liquid is introduced under pressure to the OPI 204a at a junction separate from the sample capillary 202a. The buffer liquid may be grounded anywhere along the flow path to the OPI 204a or APLJ; in FIG. 1 of the Appendix, the ground is depicted just before introduction of the buffer liquid to the APLJ. FIG. 1 of the Appendix also depicts an isolation transformer, which may be utilized if the CE sampling device 232a and mass analysis system utilize a common power supply, to electrically decouple those two components. As will be appreciated by the person of skill in the art, a separate isolation transformer may not be required depending upon the type and configuration of the power supply supporting the mass analysis system, or if separate power supplies are utilized.

FIG. 2B depicts an enlarged partial view of an example system 200b for analyzing a separated sample from an LC capillary 202b. A number of features are described above in the context of FIG. 2A and as such are not necessarily described further, but are numbered consistently herein for clarity. In general, the system 200b includes a transport liquid supply system 222b having a pump 224b, a transport liquid source 226b, and a transport liquid supply conduit 227b. The system 200bfurther includes an electrical conductor 207b for connecting the transport liquid supply conduit 227b to the removal conduit 210b, and a first electrical contact 206b connected to the transport liquid supply conduit 227b. The first electrical contact 206b and the electrical conductor 207b ensure that the transport liquid and removal conduit 210b are grounded. The LC capillary 202b is interfaced with an OPI 204b by disposing a second end of the capillary 202b having a tip 212b within a receiving volume 228b defined at least in part by a meniscus 229b. By disposing the tip 212b within the receiving volume 228b, the eluent released from the LC capillary 202b will be grounded. Thus, high conductivity liquids, which are typically incompatible with standard MS systems, may be used in the LC-MS system described herein, because the electrical contact 206b reduces the ionization suppression from the high concentration eluent discharged from the LC system and permits direct introduction of the eluent (now diluted in the transport liquid) into the OPI 204b without interfering with the separation operation of the LC system. This configuration enables the diluted eluent from the LC capillary 202b to flow directly through the OPI 204b to the electrospray electrode of the mass analysis system.

FIG. 3A depicts another enlarged partial view of an example system 300a for analyzing a separated sample from a CE capillary 302a. A number of features are described above in the context of FIG. 2A and as such are not necessarily described further, but are numbered consistently herein for clarity. In general, the system 300a includes a transport liquid supply system 322a having a pump 324a, a transport liquid source 326a, and a transport liquid supply conduit 327a. The system 300a further includes an electrical conductor 307a for connecting the transport liquid supply conduit 327a to the removal conduit 310a, and a first electrical contact 306a connected to the transport liquid supply conduit 327a. The first electrical contact 306aand the electrical conductor 307a ensure that the transport liquid and removal conduit 310a are grounded. The system 300a further includes a receiving volume 328a defined at least in part by a meniscus 329a. The CE capillary 302a is interfaced with an OPI 304a by disposing a second end of the capillary 302a having a tip 312a within the removal conduit 310a. The capillary 302amay be spaced apart from the removal conduit 310a such that there is no direct contact between the capillary 302a and the removal conduit 310a. Alternatively, the capillary 302a may be in contact with the removal conduit 310a so long as the contact does not completely block the flow of transport liquid through the removal conduit 310a. In either configuration, by disposing the tip 312a of the capillary 302a within the removal conduit 310a, the capillary is in contact with the transport liquid and the eluent from the capillary 302a is therefore grounded via the first electrical contact 306a. The capillary 302a is sized so as to provide sufficient space between the capillary 302a and the removal conduit 310a to enable flow of the transport liquid. This configuration enables the eluent from the CE capillary 302a to be diluted in the transport liquid and flow directly through the OPI 304a to the mass analysis system, while maintaining the required potential on the CE system (e.g., 20kV) and on electrospray electrode of the mass analysis system (e.g., 5 kV).

FIG. 3B depicts another enlarged partial view of an example system 300b for analyzing a separated sample from an LC capillary 302b. A number of features are described above in the context of FIG. 2A and, as such are not necessarily described further, but are numbered consistently herein for clarity. In general, the system 300b includes a transport liquid supply system 322b having a pump 324b, a transport liquid source 326b, and a transport liquid supply conduit 327b. The system 300b further includes an electrical conductor 307b for connecting the transport liquid supply conduit 327b to the removal conduit 310b, and a first electrical contact 306b connected to the transport liquid supply conduit 327b. The first electrical contact 306b and the electrical conductor 307b ensure that the transport liquid and removal conduit 327b are grounded. The system 300b further includes a receiving volume 328b defined at least in part by a meniscus 329b. The LC capillary 302b is interfaced with an OPI 304b by disposing a second end of the capillary 302b having a tip 312b within the removal conduit 310b. The capillary 302b may be spaced apart from the removal conduit 310b or in contact therewith, provide transport liquid flow is maintained, as noted above with regard to FIG. 3A. By disposing the tip 312b of the capillary 302b within the removal conduit 310a, the capillary is in contact with the transport liquid and the eluent from the capillary 302b is therefore grounded via the first electrical contact 306b. Thus, high conductivity liquids, which are typically incompatible with standard MS systems, may be used in the LC-MS system described herein, because the electrical contact 306b reduces the ionization suppression from the high concentration eluent discharged from the LC system, thus making it compatible with the mass analysis system. This configuration enables the eluent from the LC capillary 302b to be diluted in the transport liquid and flow directly through the OPI 304b to the mass analysis system.

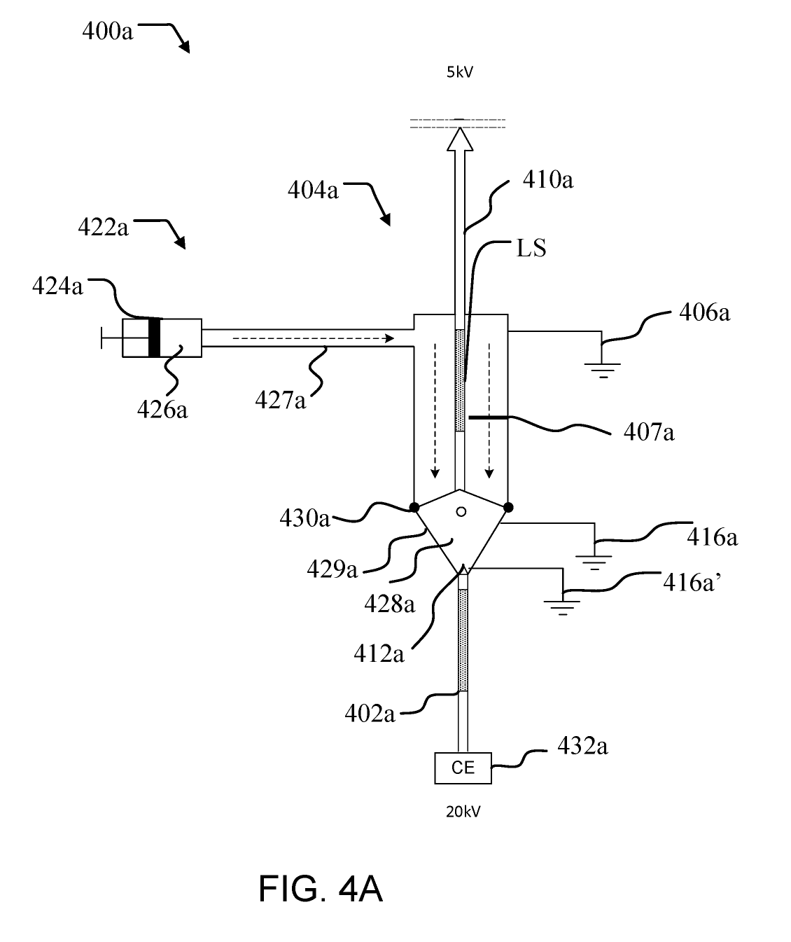

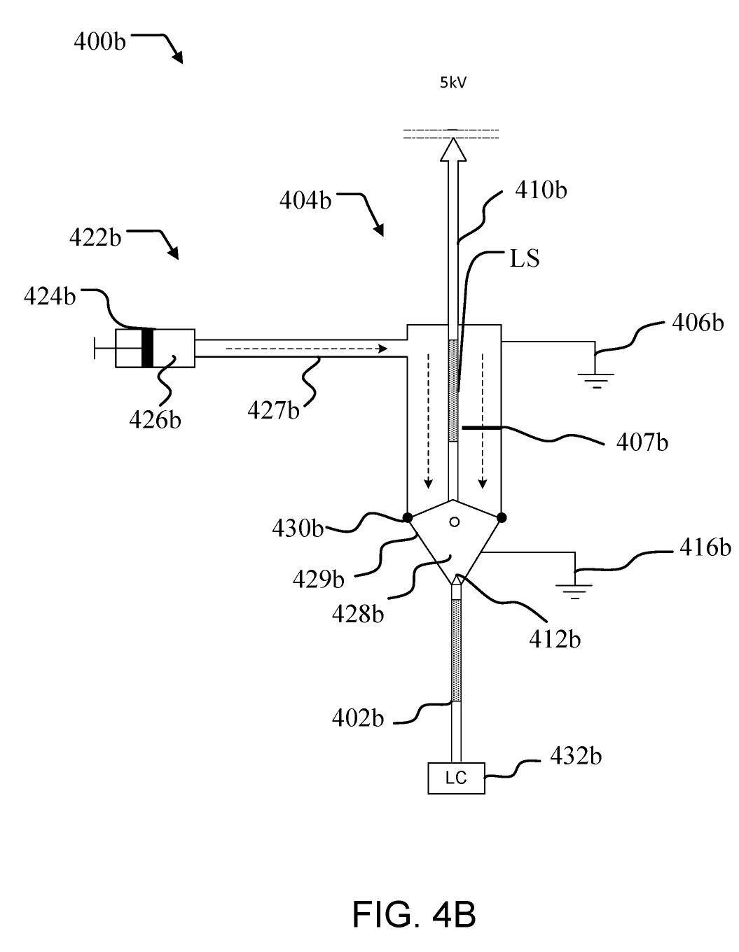

FIG. 4A depicts another enlarged partial view of an example system 400a for analyzing a separated sample from a CE capillary 402a utilizing, in this case, using a physical interface or connector 429a that may be secured to the OPI 404a via a conductive or non-conductive flexible fastener or gasket 430a. A number of features are described above in the context of FIG. 2A and, as such are not necessarily described further, but are numbered consistently herein for clarity. In general, the system 400a includes a transport liquid supply system 422a having a pump 424a, a transport liquid source 426a, and a transport liquid supply conduit 427a. The system 400a further includes an electrical conductor 407a for connecting the transport liquid supply conduit 427a to the removal conduit 410a, and a first electrical contact 406a connected to the transport liquid supply conduit 427a. The first electrical contact 406a and the electrical conductor 407a ensure that the transport liquid and removal conduit 410a are grounded. The CE capillary 402a is connected to an OPI 404a by the interface 429a, which is coupled to the transport liquid supply conduit 427a and the second end of the capillary 402a. The interface 429adefines a receiving volume 428a proximate the removal conduit 410a, and thus, is configured to receive transport liquid from the transport liquid supply conduit 427a. The interface 429a is further configured to be communicatively coupled with at least a tip 412a of the second end of the capillary 402a, e.g., via an inlet. In this example system 400a, the transport liquid floods the interface 429a. The eluent from the capillary 402acan then be received into the receiving volume 428a defined by the interface 429a, diluted in the transport liquid, and removed via the removal conduit 410a.

The interface 429a and/or fastener 430a may be conductive or non-conductive. Examples of a nonconductive interfaces 429a include, but are not limited to, a tube, chamber, or conduit comprising a non-conductive material, such as rubber or plastic. Examples of a conductive interface 429a include, but are not limited to, a tube, chamber, or conduit comprising a conductive material, such as a conductive metal (e.g., copper, aluminum, steel). Depending on the conductivity of the interface 429a and/or the fastener 430a, additional grounding conductors may be required to maintain the required potential on the CE system (e.g., 20kV) and on the electrospray electrode of the mass analysis system (e.g., 5 kV) as the OPI between the CE system and the ESI electrically isolate the CE system from the mass analysis system (e.g., a fused glass silica capillary is an insulator between the OPI and the ESI). The CE system applies a voltage, positive or negative, at one end, and a counter electrode applies a second voltage at the other end coupled to the interface 429a, which must be consistent with the voltage applied at the open end of the OPI 404a to maintain a well-defined voltage drop across the CE capillary. In examples, the fastener 430a may be a solid gasket, a chemical adhesive, or an adhesive wrap or tape. The interface 429a may include at least one flexible element or be made in whole or in part from at least one of rubber, polyurethane, neoprene, or silicone. Other fastener 430a configurations will be apparent to a person of skill in the art. Use of a non-conductive fastener 430a with a conductive fastener 429a requires a second electrical contact 416a is disposed on the interface 429a to maintain the potential required in the CE system. If the interface 429a itself is non-conductive, a second electrical contact 416a’ should be connected to the tip 412a. In examples where the interface 429a is conductive, the first electrical contact 406a is sufficient to ground the eluent from the capillary 402a, so any second electrical contact 416a’ is optional, but may be desirable.

FIG. 4B depicts another enlarged partial view of an example system 400b for analyzing a separated sample from an LC capillary 402b using an interface 429b connected via a fastener 430b. A number of features are described above in the context of FIGS. 2A and 4A and, as such are not necessarily described further, but are numbered consistently herein for clarity. In general, the system 400b includes a transport liquid supply system 422b having a pump 424b, a transport liquid source 426b, and a transport liquid supply conduit 427b. The system 400b further includes an electrical conductor 407b for connecting the transport liquid supply conduit 427b to the removal conduit 410b, and a first electrical contact 406b connected to the transport liquid supply conduit 427b. The LC capillary 402b is connected to an OPI 404b by the interface 429b, which is coupled to the transport liquid supply conduit 427b and the second end of the capillary 402b. The eluent from the capillary 402b is received by the receiving volume 428b defined by the interface 429b, diluted in the transport liquid to reduce the ionization suppression from the high concentration eluent discharged from the LC system, and removed via the removal conduit 410b. Configurations and materials for the interface 429b and fastener 430b, as well as requirements for electrical contacts 416b in view thereof, are described above in the context of FIG. 4A.

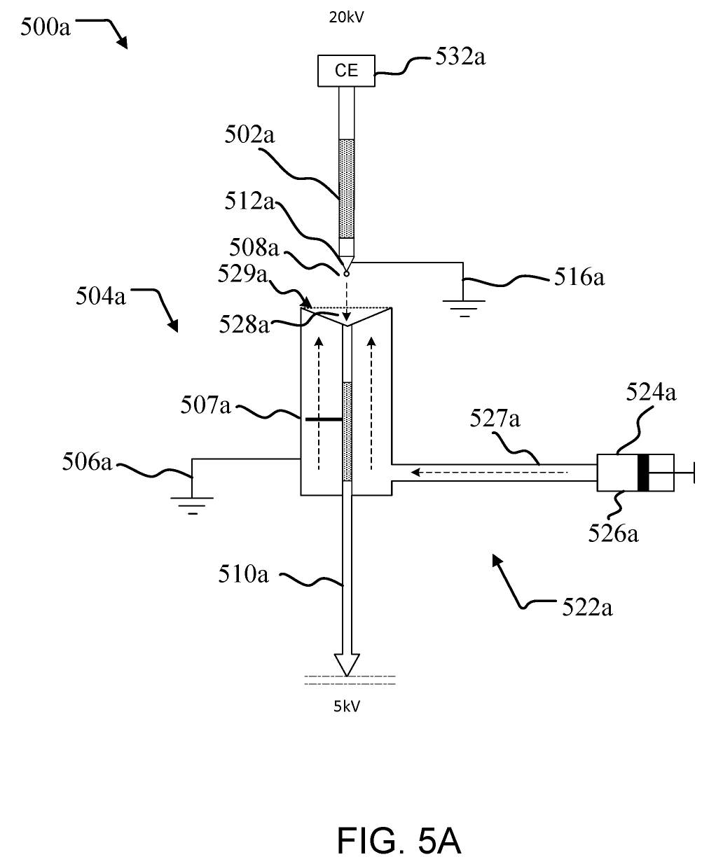

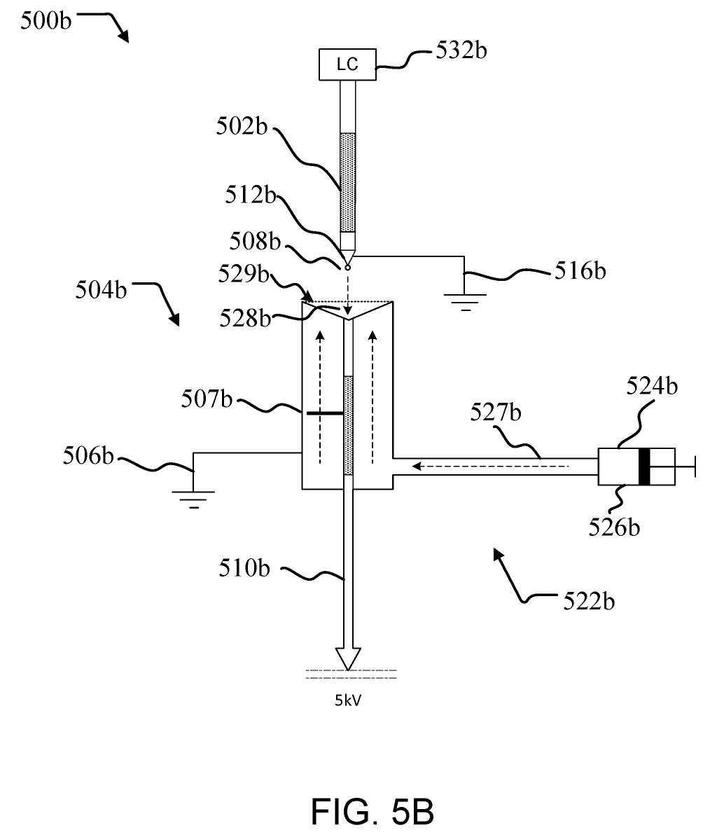

FIG. 5A depicts another enlarged partial view of an example system 500a for analyzing a separated sample from a CE capillary 502a; FIG. 5A is another configuration of the APLJ first depicted in FIG. 2A, but where a tip 512a of the sample capillary 502a is located within the atmosphere (e.g., air side of the APLJ) about the OPI 504a, rather than within a receiving volume 528a (liquid side of the APLJ) thereof. Although the OPI 504ais inverted compared to the previous examples, the components utilized therein are consistent. Thus, a number of features are described above in the context of FIG. 2A and as such are not necessarily described further, but are numbered consistently for clarity. In general, the system 500a includes a transport liquid supply system 522a having a pump 524a, a transport liquid source 526a, and a transport liquid supply conduit 527a. The system 500a further includes an electrical conductor 507a for connecting the transport liquid supply conduit 527a to the removal conduit 510a, and a first electrical contact 506a connected to the transport liquid supply conduit 527a. The first electrical contact 506aand the electrical conductor 507a ensure that the transport liquid and removal conduit 510a are grounded.

In the example system 500a, one end of the capillary 502a has a conductive tip 512a that is positioned remote from and above the open end of the OPI 504a. A droplet 508a eluent from the capillary 502a can be released from the tip 512a under gravity into a receiving volume 528a defined at least in part by a meniscus 529a. Since the tip 512a of the capillary 502a is disposed remote from and above the receiving volume 528a, a second electrical contact 516a connected to the conductive tip 512a is required to maintain potential on the CE system. Thus, when the eluent droplet 508a is released from the tip 512a of the capillary 512a, the eluent 508a is grounded via the second electrical contact 516a. The eluent is diluted in the transport liquid and then removed via the removal conduit 510a to the mass analysis system.

FIG. 5B depicts another enlarged partial view of an example system 500b for analyzing a separated sample from an LC capillary 502b. A number of features are described above in the context of FIGS. 2A and 5A and as such are not necessarily described further, but are numbered consistently herein for clarity. In general, the system 500b includes a transport liquid supply system 522b having a pump 524b, a transport liquid source 526b, and a transport liquid supply conduit 527b. The system 500bfurther includes an electrical conductor 507b for connecting the transport liquid supply conduit 527b to the removal conduit 510b, and a first electrical contact 506b connected to the transport liquid supply conduit 527b. The first electrical contact 506b and the electrical conductor 507b ensure that the transport liquid and removal conduit 527b are grounded. The capillary 502b includes a conductive tip 512b positioned remote from and above the open end of the OPI 504b. A droplet of eluent 508b from the capillary 502b can be released from the tip 512b under gravity into a receiving volume 528b defined at least in part by a meniscus 529b. A second electrical contact 516b connected to the conductive tip 512b; thus, when the eluent droplet 508b is released from the tip 512b of the capillary 502b, the eluent 508b is grounded via the second electrical contact 516b. Thus, high conductivity liquids, which are typically incompatible with standard MS systems, may be used in the LC-MS system described herein, because the electrical contact 516b reduces the ionization suppression from the high concentration eluent discharged from the LC system prior to entering the MS system via the removal conduit 510b.

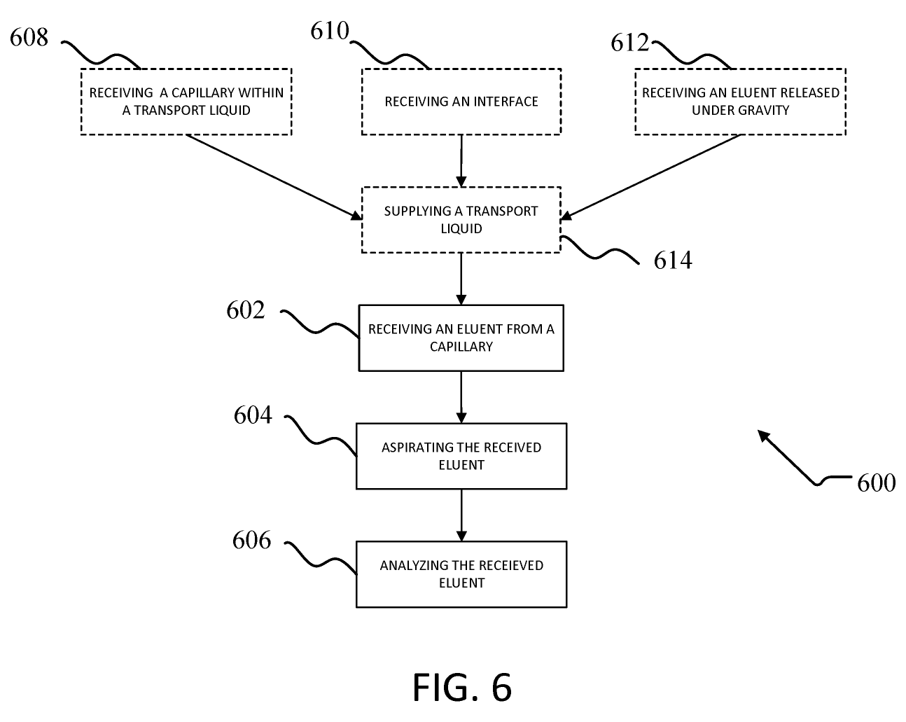

FIG. 6 depicts a method 600 for analyzing a separated sample received from a capillary. The capillary has a first end connected to a sampling device that performs either capillary electrophoresis (CE) or liquid chromatography (LC). Example systems for connecting a CE or LC sampling device are described above, for example, in FIGS. 2A-5B. The method 600 includes receiving an eluent (e.g., separated sample and solvent) from the capillary, operation 602. The eluent is received into a receiving volume defined at least in part by a transport liquid and diluted in the transport liquid. The receiving volume may be defined at least in part by a meniscus. In advance of performing operation 602, the method 600 may include supplying the transport liquid to a transport liquid supply conduit, operation 614. The transport liquid is supplied from a transport liquid supply system, which is in fluidic communication with the transport liquid supply conduit. The transport liquid flows from a transport liquid source through the transport liquid supply conduit towards an open end of an OPI, where the receiving volume is formed. A first electrical contact is connected to the transport liquid supply conduit to ground the transport liquid. The received diluted eluent is then aspirated into a liquid exhaust system, operation 604. The liquid exhaust system is in fluidic communication with a removal conduit configured to remove liquid from the receiving volume. The liquid exhaust system is described above, for example, in FIG. 1. The method continues with analyzing the received diluted eluent with a mass analysis system, operation 606.

The capillary from which the eluent is received in operation 602 may be arranged in one of a variety of example configurations, as described above in FIGS. 2A-5B. In one example, the method 600 includes receiving the second end of the capillary within the meniscus, operation 608. The second end of the capillary may be disposed within the transport liquid and outside of the removal conduit, such as in the example systems shown in FIGS. 2A and 2B. Alternatively, the second end of the capillary may be disposed within the removal conduit, such as in the example systems shown in FIGS. 3A and 3B. In these examples, the perimeter of the second of the capillary may be in contact with the removal conduit. However, the contact between the second end of the capillary and the removal conduit must be configured to allow transport liquid to flow from the receiving volume into the removal conduit.

In a second example, the method 600 includes receiving an interface defining the receiving volume proximate the removal conduit, operation 610. The interface is coupled to the transport liquid supply conduit and the second end of the capillary. Thus, once the interface is received, operation 610, an eluent from the capillary can be received, operation 602, into the interface defining the receiving volume. As described above, the interface may include at least one flexible element and may be connected to a second electrical contact. Example systems utilizing the interface received in operation 610 are described herein above, for example, in FIGS. 4A and 4B. In a third example, the method 600 includes receiving an eluent from the capillary where the eluent is released from the second end of the capillary under gravity into the receiving volume, operation 612. Example systems consistent with operation 612 are described above, for example, in FIGS. 5A and 5B. The second end of the capillary is positioned remote from and above the receiving volume such that gravity causes droplets of the eluent to be released from the tip of the capillary. Since the capillary is not in direct contact with the receiving volume, a second electrical contact is disposed on the tip of the capillary and configured to ground the eluent as it is released from the second end of the capillary.

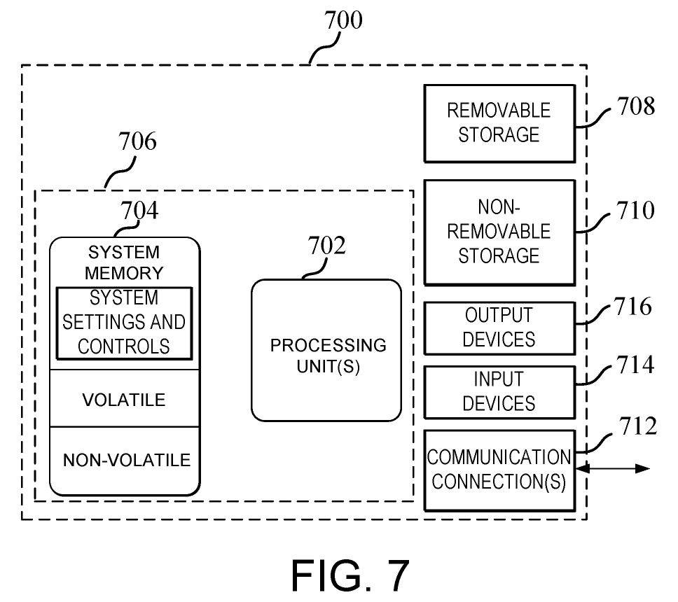

FIG. 7 depicts one example of a suitable operating environment 700 in which one or more of the present examples can be implemented. This operating environment may be incorporated directly into the controller for a mass spectrometry system, e.g., such as the controller depicted in FIG. 1. The controller may further interface with a CE or LC system that supplies eluents to the OPI. This is only one example of a suitable operating environment and is not intended to suggest any limitation as to the scope of use or functionality. Other well- known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 700 typically includes at least one processing unit 702 and memory 704. Depending on the exact configuration and type of computing device, memory 704 (storing, among other things, instructions to control the sampling device, release of eluent from the capillary, liquid flow rates, interface operation of the CE or LC with that of the MS, etc., or perform other methods disclosed herein) can be volatile (such as RAM), non-volatile (such as ROM, flash memory, etc.), or some combination of the two. This most basic configuration is illustrated in FIG. 7 by dashed line 706. Further, environment 700 can also include storage devices (removable, 708, and/or non-removable, 710) including, but not limited to, magnetic or optical disks or tape. Similarly, environment 700 can also have input device(s) 714 such as touch screens, keyboard, mouse, pen, voice input, etc., and/or output device(s) 716 such as a display, speakers, printer, etc. Also included in the environment can be one or more communication connections 712, such as LAN, WAN, point to point, Bluetooth, RF, etc.

Operating environment 700 typically includes at least some form of computer readable media. Computer readable media can be any available media that can be accessed by processing unit 702 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term "modulated data signal" means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 700 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 700 that can be stored on computer storage medium and other tangible mediums and transmitted in communication media. Computer storage media includes volatile and non-volatile, removable and non- removable media implemented in any method or technology for storage of information such as computer readable instructions, data structures, program modules, or other data. Combinations of any of the above should also be included within the scope of readable media. In some examples, computer system 700 is part of a network that stores data in remote storage media for use by the computer system 700.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A sample processing system comprising:
a separation capillary located to deliver an eluent from a capillary electrophoresis (CE) system into a transport liquid in a receiving volume of an open port interface for delivery of the eluent to an analytical instrument,
wherein the separation capillary is electrically decoupled from the analytical instrument.

2. The sample processing system of claim 1, wherein the transport liquid comprises a buffer liquid delivered from the CE system.

3. The sample processing system of claim 1, wherein the receiving volume comprises an air-liquid interface at atmospheric pressure.

4. The sample processing system of claim 3, wherein a tip of the separation capillary is disposed on an air side of the air-liquid interface.

5. The sample processing system of claim 4, wherein a tip of the separation capillary is disposed on a liquid side of the air-liquid interface.

6. The sample processing system of claim 2, further comprising an isolation transformer electrically decoupling the CE system from the analytical instrument.

7. A system comprising:
a capillary having a first end connected to a sampling device and a second end, wherein the sampling device is configured to separate a sample with a separation solution and deliver the sample and the separation solution to the second end;
a transport liquid supply system in fluidic communication with a transport liquid supply conduit that provides a transport liquid from a transport liquid source through the transport liquid supply conduit, wherein the transport liquid provided from the transport liquid supply conduit comprises a receiving volume defined at least in part by a meniscus, the transport liquid in the receiving volume is electrically grounded relative to the first end, and wherein the second end of the capillary is in fluidic communication with the receiving volume;
a liquid exhaust system in fluidic communication with a removal conduit that removes liquid from the receiving volume; and
an analysis system in fluidic communication with the removal conduit.

8. The system of claim 7, wherein the second end of the capillary is disposed within the meniscus and further comprising a capillary ground contact in fluid contact with at least part of the receiving volume.

9. The system of claim 7, wherein the second end of the capillary is disposed in the removal conduit and wherein the capillary ground contact comprises at least in part a conduit wall of the receiving volume.

10. The system of claim 7, wherein a perimeter of the second end of the capillary is spaced apart from the removal conduit.

11. The system of claim 7, further comprising an interface coupled to the transport liquid supply conduit and the second end of the capillary, wherein the interface defines the receiving volume proximate the removal conduit.

12. The system of claim 7, wherein the second end of the capillary further comprises a conductive tip and wherein the receiving volume is grounded by the conductive tip.

13. The system of claim 7, wherein the interface comprises at least one flexible element.

14. The system of claim 13, wherein the flexible element comprises at least one of rubber, polyurethane, neoprene, and silicone.

15. The system of claim 7, wherein the sampling device performs capillary electrophoresis or liquid chromatography.

16. The system of claim 7, wherein the analysis system is a mass spectrometer.

17. The system of claim 7, wherein the second end of the capillary further comprises a conductive tip, wherein the conductive tip is disposed above a meniscus of the receiving volume, and wherein the sample and the separation solution is grounded by the conductive tip.

18. A method for analyzing a sample, the method comprising:
receiving the sample and a separation solution from a capillary into a receiving volume defined at least in part by a transport liquid delivered from a transport liquid supply conduit, while electrically grounding the transport liquid;
aspirating the transport liquid, received sample and the separation solution into a liquid exhaust system in fluidic communication with a removal conduit in fluidic communication with the receiving volume; and
analyzing the received sample and separation solution with a mass analysis system.

19. The method of claim 18, the method further comprising supplying the transport liquid to the transport liquid supply conduit from a transport liquid supply system in fluidic communication with the transport liquid supply conduit.

20. The method of claim 18, wherein the receiving volume is defined at least in part by a meniscus.

21. The method of claim 8, the method further comprising receiving the second end of the capillary within the meniscus.

22. The method of claim 18, wherein a perimeter of the second end of the capillary is in contact with the removal conduit.

23. The method of claim 18, the method further comprising receiving an interface defining the receiving volume proximate the removal conduit.

24. The method of claim 23, wherein the interface comprises at least one flexible element.

25. The method of claim 18, wherein the sampling device performs at least one of capillary electrophoresis and liquid chromatography to obtain the sample.

26. The method of claim 18, the method further comprising receiving the sample and the separation solution from the capillary, wherein the sample and the separation solution are released from the second end of the capillary under gravity into the receiving volume.

27. The method of claim 18, wherein the separation solution is diluted by the transport liquid to allow for ionization by the mass analysis system.
